(19) United States
(12) Patent Application Publication
(10) Pub. No.: US 2025/0037160 A1
(43) Pub. Date: Jan. 30, 2025

(54) METHOD AND SYSTEM FOR PROVIDING AI RECOGNITION AND LOCATION-BASED REWARDS AND INCENTIVES FOR PRODUCT OWNERS AND MOBILE APP USERS

(71) Applicant: RODAC TECHNOLOGIES LTD., Seoul (KR)

(72) Inventors: Grant Warren WOODFORD, Seoul (KR); Robert Adam KOKOSZKA, Seoul (KR); Haein KIM, Seoul (KR)

(73) Assignee: RODAC TECHNOLOGIES LTD., Seoul (KR)

(21) Appl. No.: 18/706,815

(22) PCT Filed: Nov. 4, 2022
(86) PCT No.: PCT/KR2022/017190

§ 371 Date: May 2, 2024

(30) Foreign Application Priority Data
Nov. 4, 2021 (KR) 10-2021-0150357

(51) Int. Cl. G06Q 30/0235; G06Q 30/0251

(52) U.S. Cl. CPC G06Q 30/0235; G06Q 30/0261; G06Q 30/0267

(57) ABSTRACT

A method and system for providing artificial intelligence recognition and location-based rewards and incentives for product owners and mobile application users are provided. The method may include registering a PRU (Passive Rewards User), activating a PRP (Passive Reward Period), an ARU (Active Rewards User) scanning a product and receiving a reward, and a LMS (Location Matching Server) performing cross-verification and issuing a reward.

### CROSS-REFERENCE TO RELATED APPLICATIONS

This application is a 35 U.S.C. § 371 national phase of PCT International Application No. PCT/KR2022/017190, filed Nov. 4, 2022, which claims the benefit of priority under 35 U.S.C. § 119 to Republic of Korea Patent Application No. 10-2021-0150357, filed Nov. 4, 2021, the contents of which are incorporated herein by reference in its entirety.

### FIELD

The disclosed content relates to a system for providing artificial intelligence recognition and location-based rewards and incentives for the owners of products, such as automobiles, bags, shoes, or other consumer goods, and mobile application users. Specifically, it pertains to a method and system where a product is scanned using a mobile application, triggering the provision of information and advertisements. If the scan occurs within a predefined radius, rewards and incentives are distributed to both the mobile application user and the product owner.

### BACKGROUND

Augmented Reality (AR) overlays virtual objects or environments on real objects, combining information in a way that can be implemented through mobile devices like smartphones and AR smart glasses. AR has become a valuable tool in real life, enabling new brand experiences and marketing opportunities, with many companies utilizing AR technology for marketing. Technologies that provide rewards in conjunction with AR are being developed. For example, rewards can be offered based on a user's engagement with new brand products or advertisements.

However, most reward systems are limited to pre-purchase activities, like viewing advertisements or virtual images of products, with little research into reward systems that provide direct compensation to product owners post-purchase. Even with AR technology, current AR advertising systems do not compensate product owners when consumers use mobile devices to view the owner's products.

### SUMMARY

The technical problem addressed is how to provide a method and system that rewards both mobile application users and product owners when a product is scanned under predefined conditions.

A method according to an embodiment may include registering a Passive Rewards User (PRU) and activating a Passive Reward Period (PRP); an Active Rewards User (ARU) scanning the product and receiving rewards; and a Location Matching Server (LMS) performing cross-verification and issuing rewards.

Some embodiments may involve the PRU taking a photo of the product with their mobile device and an image recognition AI server providing product identification information.

The PRU registration and PRP activation may include sending a timestamp indicating the start of the PRP and a location of the PRU to the LMS.

When an ARU scans a product, the image recognition AI server may provide product information identified by the ARU's mobile device, leading to rewards.

The LMS may cross-verify if the ARU, through a mobile device scan, is within a predefined distance from the product, based on the PRU's location in the Product Ownership Database (POD) and PRP, and provide rewards accordingly.

According to the embodiments, this invention allows for cost-effective, regulation-free advertising using owned products and creates new methods/spaces for digital advertising. It matches mobile application users with advertisers for low-cost, high-efficiency marketing, performs advertisements based on AI product recognition and scan location data, provides product information and rewards, and allows product owners to also receive rewards anywhere, making them advertising agents in the process.

### BRIEF DESCRIPTION OF THE DRAWINGS

FIG. 1 is a drawing for explaining a system according to an embodiment.

FIG. 2 is a drawing for explaining the operation of a Location Matching Server that tracks the location of registered products and mobile application users, according to an embodiment.

FIG. 3 is a drawing for explaining a passive reward, according to an embodiment.

FIG. 4 is a drawing for explaining the differences between a tethered mode and an untethered mode, according to an embodiment.

FIG. 5 is a drawing for explaining a system according to an embodiment.

FIG. 6 is a drawing for explaining a computing device, according to an embodiment.

### DETAILED DESCRIPTION

Below, embodiments of the present invention are described in detail with reference to the attached drawings, so that those of ordinary skill in the technical field to which the invention pertains can implement them. However, the invention can be implemented in various forms and is not limited to the embodiments described herein. Parts not related to the explanation have been omitted from the drawings for clarity, and similar parts throughout the specification have been marked with similar reference numerals.

Throughout the specification and claims, when a part is said to “include” a component, it means that it can include other components, not exclude them, unless specifically stated otherwise. Terms including ordinal numbers such as “first”, “second”, etc., can be used to describe various components, but the components are not limited by these terms. These terms are only used to distinguish one component from another.

The terms “ . . . unit”, “ . . . device”, “module”, etc., mentioned in the specification, refer to units that process at least one function or operation, which can be implemented in hardware, software, or a combination of hardware and software. Furthermore, at least some of the system and method configurations or functions described according to the embodiments can be implemented as programs or software, and the program or software can be stored on a computer-readable medium.

The embodiments can provide rewards to both owners (product owners, passive users) of products and consumer goods such as cars, shoes, bags, etc., and non-owners (mobile application users, active users) who confirm these products and consumer goods through an augmented reality-based display, via a system (or server) integrated with an image recognition AI system (or image recognition AI server). Direct benefits can be provided to the product owner whenever someone else views the owner's products like cars, bags, shoes, etc., through a mobile device.

At the same time, the embodiments can provide a free, non-physical, and unregulated advertising method to product owners, allowing them to passively earn income from their own products and become advertisers themselves, offering a new space for advertising using AR digital content.

For example, car owners spend money on maintenance, management, and repair of their cars, but it is difficult to generate income using the owned car. Although advertising methods using cars are becoming more diverse, including car advertising or attaching advertisements to personal cars for specific brand promotions, the costs of creating advertisements and the exposure to people, car owners, can be considered detrimental to traffic safety or urban aesthetics. Physical advertising methods like wrapping or attaching display devices have legal constraints, limiting the advertising and revenue-generating methods using cars, and the advertisement content targeting a general audience remains unchanged over a certain period, making it impossible to match consumers or advertisers. The embodiments can operate similarly for other similar products or consumer goods like shoes, clothing, bags, jewelry, etc., allowing owners to passively earn income from their products.

The embodiments can provide a method and system for artificial intelligence recognition and location-based rewards and incentives for product owners and mobile application users, where the product owner, as a user, can receive rewards through the process of another user scanning their owned car via a mobile application.

In the given example, the method may include steps for registering a Passive Rewards User (PRU) and activating a Passive Reward Period (PRP); scanning by an Active Rewards User (ARU) and rewarding; and cross-verification and rewarding by a Location Matching Server (LMS). Here, PRUs are product owners or passive users, and ARUs can be non-owners, mobile application users, or active users.

During the PRU registration and PRP activation phase, a product photo can be captured (or scanned) using the mobile device of a PRU, and an image recognition AI server can receive a product identification request. This server can provide the PRU's mobile device with product identification information about the identified product. The product identification information can be sent to a Product Ownership Database (POD), creating a database entry in the PRU's registered product list. Next, a timestamp indicating the start time of the PRP and the PRU's request to activate the PRP can be sent to the LMS, which can then provide an activation notification to the PRU's mobile device. In this manner, once the PRP is activated, the PRU's location (e.g., GPS location) can be provided to the LMS through the PRU's mobile device.

In the ARU scanning and rewarding phase, a product photo can be captured (or scanned) using the ARU's mobile device, and the image recognition AI server can receive a product identification request. The server can provide the ARU's mobile device with information about the identified product, after which the ARU can be rewarded (e.g., with in-application points, linked cryptocurrency, etc.).

During the LMS cross-verification and rewarding phase, after a product is scanned by the ARU and identified by the image recognition AI server, the LMS can request and receive the list of PRU-registered products from the POD. The LMS can provide a list of PRUs with activated PRPs. It can then cross-verify which PRUs are within a predefined distance (e.g., 500 meters) from the product scanned by the ARU, based on the POD and PRP, and identified by the LMS. If it is confirmed that they are within the predefined distance and inside the activated PRP, rewards (e.g., in-application points, linked cryptocurrency, etc.) can be provided to the PRU in the POD.

Furthermore, product owners can also be referred to as PRUs, passive users, passive reward users, etc., and non-owners can be referred to as ARUs, active users, active reward users, etc. For clarity in the description, automobiles are used as an example of products, but the invention is not limited to automobiles and can apply to any consumer goods, such as bags and shoes.

In some examples, the system allows product owners to receive rewards through a gamified process where other users (non-owners) scan their owned products using a mobile application. The location matching system can use AI recognition, mobile devices, and geographical location information to enable product owners to benefit when their products are scanned.

When the car of a passive reward user (a member of the system) is scanned by other active reward users, the car owner can receive in-application points, which can be converted into real goods or cryptocurrency coins. Thus, car owners can passively gain benefits through their cars. The system has advantages of increasing user engagement, providing promotional and advertising opportunities, and collecting data. It can also identify valuable users, such as social media influencers, as product owners, encouraging others to frequently scan the influencer's car model, thus turning them into advertisers themselves.

Passive reward users can have their advertising influence tier determined by how many active reward users scan their car. They may receive incentives to help the system gain more users and can provide sign-up codes to non-users. Active reward users scanning a passive reward user's car can receive bonus points.

Additionally, the system allows advertising business partners to purchase ads linked to specific car models through programmatic ad buying methods based on conditions like daily attributes or specific user locations and times. When an active reward user scans a passive reward user's car, the business partner's advertisement can be displayed on the mobile application. Passive reward users can receive a percentage of the ad revenue generated from scans of their cars by active reward users.

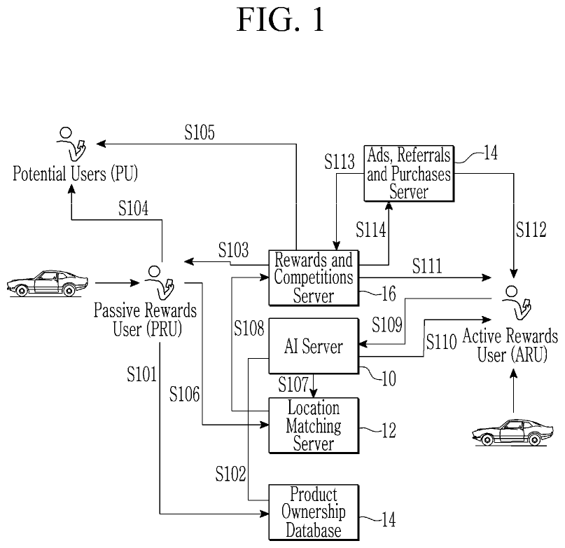

FIG. 1 illustrates a system according to an embodiment of the invention.

Referring to FIG. 1:—**S101**: A Passive Rewards User (PRU) can register their car by scanning it into the Product Ownership Database (POD) (14). The POD (14) is capable of tracking each car registered by a PRU.

**S102**: The scanned registered car can be verified through an Artificial Intelligence (AI) Server (10), which is able to determine the car's manufacturer, model, year, and color. This ensures that the registered car's details are correctly recorded, and the AI Server (10) can also identify additional information about the car, such as wheels, trim packages, and detailing.

**S103**: Upon registering their car, a PRU can receive rewards. They can periodically check with the Rewards and Competition Server (16) to verify rewards related to potential users (PUs) who use their sign-up code or for points/rewards related to passive reward scans. PRUs can also receive points/rewards or revenue share from advertisements displayed when an ARU scans their car.

**S104**: Potential Users (PUs) may not yet be members of the system. PRUs can issue a sign-up code to PUs to encourage new user registration. This incentivizes influential PRUs with many social media followers, helping the system acquire new users at a lower cost.

**S105**: PUs can join the system using the provided sign-up code, with both PUs and PRUs receiving sign-up points/rewards. PUs can be notified of the points/rewards offered for using the sign-up code.

**S106**: PRUs can activate a Passive Reward Period (for example, unlocking passive rewards for the next 6 hours). During this period, PRUs can receive passive rewards when other users (Active Rewards Users—ARUs) scan their car. The PRU's location is periodically transmitted to the Location Matching Server (12), possibly every 15 minutes, to facilitate matching the ARU's scan with the location of the PRU's car.

**S107**: The AI Server (10) can record car scans performed by ARUs, storing details such as the car's manufacturer, model, year, color, location, and the ARU's user ID.

This scan information can be forwarded to the Location Matching Server (12).

**S108**: The Rewards and Competition Server (16) receives match results (whether an ARU has scanned a PRU's registered car within a specific area) and can issue appropriate rewards to both PRUs and ARUs.

**S109**: ARUs can use a mobile application to take pictures or scan actual cars. The mobile device can preprocess the photo to reduce image size and improve bandwidth efficiency before sending it to the AI Server (10). The preprocessing stage may involve cropping the captured photo to the necessary dimensions before sending it to reduce the workload on the AI Server (10).

**S110**: The AI Server (10) can identify the scanned car's manufacturer and model, responding with the results. It uses a deep learning classification model (Convolutional Neural Network) to classify the car's manufacturer and model from the scanned image. The AI Server (10)'s classification model is fully trained using a dataset of car models verified before being deployed in the system.

**S111**: ARUs receive points for scanning cars, which can be converted into rewards or goods.

**S112**: ARUs can receive in-application advertisements and recommendation services related to the car scan. Partners can decide how the advertisement/recommendation content is displayed. Filtering criteria for displaying this content can be based on specific times of the day, user location, the particular car manufacturer/model scanned, or specific PRUs (top-tier users, influencers, celebrities) owning a specific car. Auction systems can be used for advertising partners to bid for desired advertisement/recommendation criteria.

**S113**: Active Rewards Users (ARUs) can participate in referral programs and receive points/rewards. When a PRU's passive reward car is scanned or related advertisements are displayed, a portion of the ad revenue or additional points can also be provided to the PRU. A programmatic ad buying system known as the Dynamic Slot System (DSS) uses a bidding process allowing advertisers to bid for the right to advertise in specific ad slots. These ad slots will display advertisements connected to specific times, locations, car manufacturer/model, user demographics, events, or cars of specific PRUs being scanned. PRUs attracting many ARU scans have an advantage as their cars are frequently scanned. The Rewards and Competition Server (RCS) designs competitions/rewards based on the ad slots purchased at the highest price by advertisers, benefiting both advertisers and PRUs. The most valuable competitions and rewards generated by the system are allocated to the highest-priced ad slots. The system collects data related to what brings the greatest benefit to advertisers, including click-through rates, referrals, store visits, web page views, etc., related to competitions, car models/brands, PRU influence factors, locations, demographics, and times. Recorded advertising statistics for each ad slot help advertisers decide on the most valuable or relevant ad slots. Generated ad slots are sent to RCS (16) to be used in creating competitions and deciding on rewards, generating more competitions and rewards for more valuable ad slots. If two ad slots are relatively similar, the one with a higher bid is rewarded with better competition and rewards when the advertisement is displayed. This increases the value of the winning ad slot bid as more missions with better rewards (attracting more ARU scans) are automatically generated and prevents other advertisers from generating too many similar bid slots, potentially lowering possible bid values.

**S114**: Scan data from ARUs is identified and recorded by the AI Server (10) and then can be passed to the Location Matching Server (LMS) (12). The LMS (12) can verify the scan location, check the distance to the PRU, and add “location metadata” to the “scan metadata” to create “combined metadata.” The LMS (12) can then pass the “combined metadata” to the Rewards and Competition Server (16) to verify and award points, adding “reward-competition metadata” to the “combined metadata” to create “final metadata.” RCS (16) can pass the “final metadata” to the Advertising, Recommendation, and Purchasing Server (14). ARPS (14) can generate dropdown menu options for advertisers to select in the DSS based on the “final metadata.” Advertisers can create their desired ad slot for bidding based on dropdown menu selections of metadata variables (e.g., location, time, ARU demographics, car specifications). Advertisers can also view Displayed Associated Metadata (DAM) related to the selected variables (e.g., click-through rates, conversion rates, user engagement statistics, demographic information). All advertisers can view the newly created bid slot and bid on it in the auction simultaneously. Each ad slot has a designated bid timer (e.g., 24 hours), and the highest bid at the end of this timer gains the right to display their chosen advertisement in that specific ad slot. Advertisers can upload their chosen advertisement for the won slot via API and/or a web portal. Using DSS, advertisers can bid on slots actively used by application users, maximizing efficiency and avoiding unseen or less popular slots. DSS allows advertisers to see which slots are more or less popular based on DAM. Advertisers preferring to pay less can identify slots that are less popular but sufficiently match their target market based on the displayed metadata. Additionally, system operators can manually create multiple bid slots, and if advertisers select variables matching those pre-made slots, they can be redirected to bid on these pre-made slots.

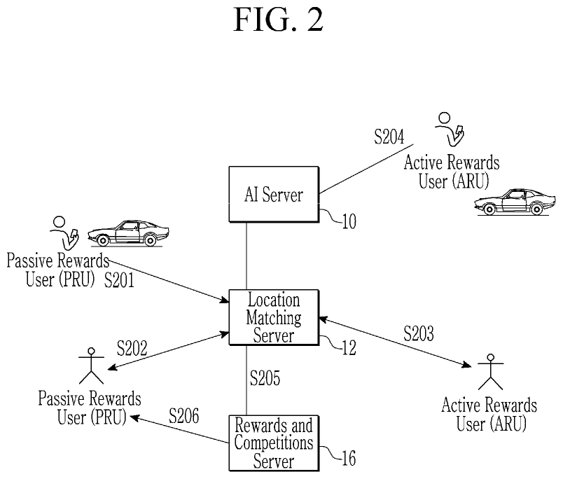

FIG. 2 is a drawing to explain the operation of a Location Matching Server that tracks registered cars and user locations according to an embodiment.

Refer to FIG. 2, in S201, to activate the passive reward period, the PRU can scan their car with a mobile application to register the car location to the location matching server (12). This scan can be verified at the AI server (10) to confirm if the scanned car matches the PRU's registered car model in the Product Ownership Database (POD). The scan timestamp and the passive reward period limit time can be tracked by the location matching server (12).

S202 can be described in relation to the tethered mode and the untethered mode.

Tethered Mode

When the PRU activates the passive reward period, the passive user can freely move away from the car within a designated distance. The passive reward period remains activated as long as the PRU is still within a certain distance from their car's location. The PRU's mobile device can periodically (for example, every 15 minutes) transmit the GPS location to the location matching server (12). The distance between the car and the PRU's last recorded location can be calculated and verified by the location matching server (12) for the maximum distance limit required to maintain the passive reward period (for example, the PRU must be within 500 meters of the car, the PRU can obtain or purchase booster items to increase this distance). Additionally, the location matching server (12) can serve to verify if the passive reward period has expired. The PRU's current location, the distance to the registered car, and the remaining time of the passive reward period can be tracked via the PRU's mobile device. Therefore, to award points, the location matching server must meet and verify the following conditions:

Conditions and verifications for the location matching server to award points—
(a) The PRU must scan the car to activate the passive reward period.
(b) The ARU verifies that the car scanned by the ARU matches the car activated by the PRU for the passive reward period.
(c) The last verified location of the PRU must be within a specified distance (e.g., 500 m) from the IPRAP (Initial Passive Rewards Activation Position) at the time of the ARU's scan.
(d) The last recorded location of the PRU must not be older than the specified location verification time (e.g., every 15 minutes).

If the PRU's mobile device is turned off: Assuming the server verifies the PRU's location every 15 minutes, and the server verified the PRU's location at 10:00, and the PRU's device was turned off at 10:09, if the ARU scans at 10:10, the reward will be given to the PRU, but if the ARU scans at 10:16, the reward will not be given to the PRU.
(e) The ARU's scan must be conducted within a specified distance (e.g., 10 meters) of the IPRP.
(f) The passive reward period must still be active and not expired.
(g) The ARU must not have a record of scanning the same car registered by the PRU during the same passive reward period.

Untethered Mode

The PRU can activate a manual reward period in “untethered” mode, where it can receive rewards without being within the initial manual reward activation location (IPRAP) through in-application item purchases. After the initial activation scan is completed, the ARU can still receive points regardless of the PRU's initial manual reward activation location (IPRAP) when scanning automobiles. The location matching server (12) first checks the automobile scanned by the ARU against the currently activated manual program automobile list and secondly checks if the automobile scanned by the PRU is in untethered mode. If the scanned automobile meets both criteria, the location matching server can check for the presence of a PRU nearby and measure the distance to the ARU scan location. If the PRU, which activated the untethered mode manual reward period, is within a specified distance from that ARU scan location, it receives points. In the untethered mode, the ARU scan is only verified for the PRU's location. While the activation location is not required in untethered mode, it is necessary in tethered mode. Therefore, for the system to award points, the location matching server must meet and verify the following conditions:
Conditions and verification required by the location matching server for point issuance.
(a) To activate the manual reward period, the PRU must scan an automobile.
(b) The automobile scanned by the ARU must match the one activated by the PRU for the manual reward period.
(c) The last verified location of the PRU must be within a specified distance (e.g., 500 m) from the ARU scan location. Tethered mode requires specified distance information from the initial activation location.
(d) The last server-verified location of the PRU (i.e., the user device) must not be outdated beyond the server location update verification time (e.g., checked every 15 minutes).

If the PRU mobile device is turned off: Assuming the server checks the PRU location every 15 minutes, if the server verified the PRU's location at 10:00 and the PRU's device was turned off at 10:09, and the ARU scanned at 10:10, the PRU would receive a reward. However, if the ARU scanned at 10:16, the PRU would not receive a reward.
(e) The manual reward period must still be active and not expired.
(f) The ARU must not have previously scanned the same automobile registered by the PRU during the same manual reward period to receive points.

In S203, the location matching server (12) can track the ARU. The ARU's device periodically sends its location to the location matching server (12). The ARU's device requests the location of the manual reward automobile along with the manual reward period time limit. For example, all manual reward automobiles within 500 meters are displayed to the ARU, and the distance can be increased using in-application purchase boosters or rewards. The ARU must move to the location of the manual reward automobile to scan and receive rewards. To receive assigned rewards during the passive reward period, the ARU must be within a close distance of the registered location of the passive reward automobile. For instance, the ARU must be within 10 meters of the manual reward automobile location. The location matching server (12) verifies the automobile's make/model/year/color and the validity of the manual reward period before awarding points/rewards.

In S204, if the user is within a specified distance of the manual reward automobile, the ARU can receive rewards for scanning the manual reward automobile. The ARU's mobile application notifies the user when they are within the necessary distance to scan the manual reward automobile. The scan record is transmitted from the ARU's mobile device to the Al server (10). The AI server (10) identifies the scanned automobile's make/model/year/color. The AI server (10) classifies to check if additional points/rewards can be received for the manual reward automobile in that area, and the scan location information is sent to the location matching server (12). As determined by the location matching server (12), if the scan timestamp is within the period passively rewarded, and the scanned location is within the designated distance from the registered automobile location for rewards, and the scanned automobile's make and model match the manual reward registered automobile model, a manual reward match occurs. Additionally, the location matching server (12) ensures that each ARU can only acquire points/rewards once during a given manual reward period. The classification of automobile models and the points/rewards earned are transmitted back to the ARU's phone to notify the user.

In segment S205, the Active Reward User (ARU) receives rewards for scanning passive reward cars within a valid area, and the Passive Reward User (PRU) also receives points/rewards. All points/rewards earned are transmitted back to the ARU's mobile application in response to each scan.

In segment S206, the mobile application of each PRU periodically checks how many rewards have been acquired passively from the reward and competition server.

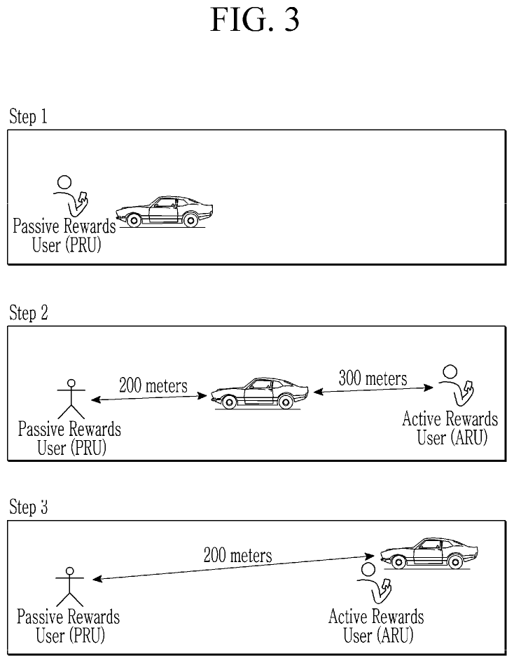

FIG. 3 illustrates a drawing for explaining passive rewards according to an embodiment of the invention.

Referring to step 1, to activate the passive reward period (e.g., to obtain passive rewards for the next 6 hours), the PRU must scan a car to start the passive reward period. The scan location of the PRU generates a location tag of where the car was last located.

Referring to step 2, once the passive reward period starts, the PRU can freely move away from the scanned car (e.g., go for coffee or shopping). To obtain scan passive rewards, the PRU must be within a certain distance (e.g., 200 meters) from the car, depending on the PRU's tier level. Meanwhile, the ARU can check for passive reward cars within a specific distance (e.g., 300 meters) depending on the tier level. Active Reward Users (ARU) can check for passive reward cars within a certain distance (e.g., 300 meters) on an in-application map, depending on the tier level. This radius can be extended through in-application booster purchases.

Referring to step 3, the ARU can find the car either at the PRU's initial scan location or by chance, scan the car to receive rewards. Both PRU and ARU earn points for this scan. Then, the ARU is taken to a specific car model profile page, where advertisements are also displayed. The PRU can receive a share or percentage of the advertising revenue generated from the ads checked by the ARU after reaching a certain threshold number (e.g., after 1000 scans).

In some embodiments, the PRU can purchase boosters to increase the period or frequency in which passive reward periods can occur or to increase the designated distance the PRU can be from the car to receive passive rewards. Similarly, boosters can be purchased by the ARU to scan passive reward cars from a greater distance.

For example, an ARU can check for passive reward cars within 300 meters on an in-application map, but with a booster purchase, they can check twice as far. The rewards/points granted to the PRU are related to the number of car scans by the ARU or the number of PUs signed up using a registration code.

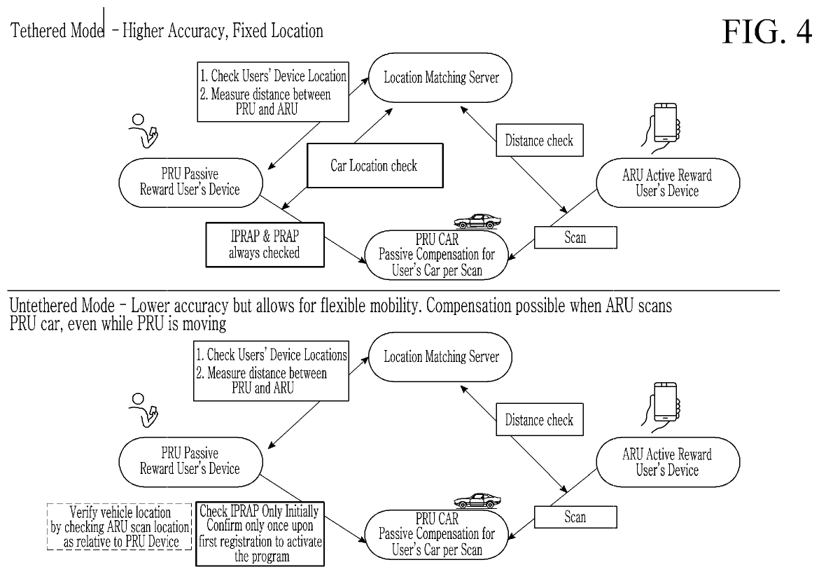

FIG. 4 illustrates a drawing for explaining the difference between tethered mode and untethered mode according to an embodiment of the invention.

In Tethered Mode—Pin Car Location (remain immobile with car):

In tether mode, information on PRU location, ARU scan location, and PRU registered car activation location (IPRAP) is applied. That is, both the car and the PRU must be within a designated distance when the ARU scans the car to be rewarded.

If the car and PRU move, they must scan again to activate and inform the server of the location information.

This mode is used when users stay in the space where the car is located or have no need to move.

In Untethered Mode—Pin User Location:

Checks the location of the PRU and the ARU scan location, with scanning of the registered car used only for activation.

If the PRU is within a specified distance when the ARU scans the car, both are rewarded.

IPRAP information is not applied when rewarding.

If the PRU is driving and the ARU scans the PRU's car, a bonus reward is given, but this is not possible in tether mode.

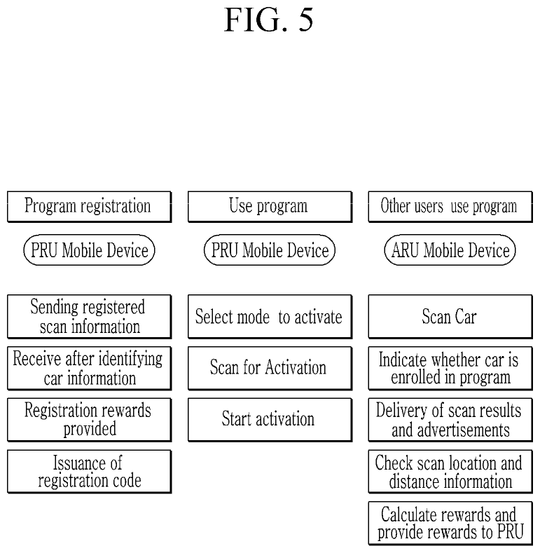

FIG. 5 is a diagram for explaining a system according to an exemplary implementation.

Referring to FIG. 5, the PRU mobile device can transmit registration scan information, receive car information after identification, provide registration rewards, and issue registration codes. Meanwhile, it can also perform mode selection, scanning for activation, and the start of activation. The ARU mobile device can scan the car, display whether the car is registered in the program, deliver scan results and advertisements, verify scan location and distance information, and calculate and provide rewards to the PRU.

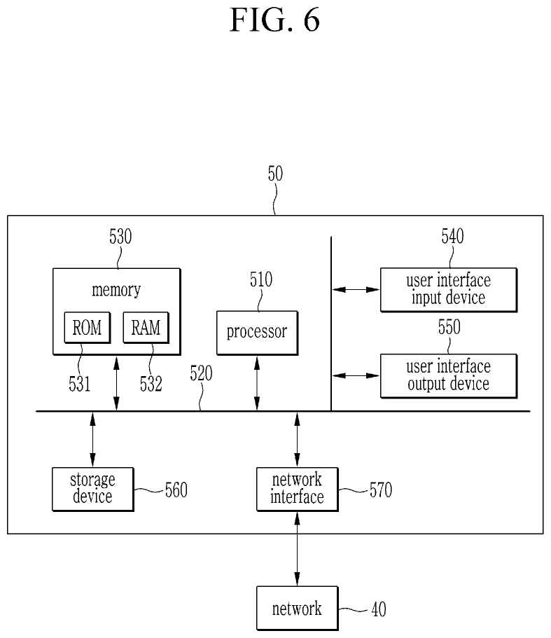

FIG. 6 is a diagram for explaining a computing device according to an exemplary implementation.

Referring to FIG. 6, the computing device (50) according to an exemplary implementation can implement the systems and methods according to the embodiments. The computing device (50) may include at least one of a processor (510), memory (530), user interface input device (540), user interface output device (550), and storage device (560), all of which communicate via a bus (520). The computing device (50) may also include a network interface (570) that is electrically connected to the network (60). The network interface (570) can transmit or receive signals to other devices through the network (60).

The processor (510) can be implemented in various types such as an MCU (Micro Controller Unit), AP (Application Processor), CPU (Central Processing Unit), GPU (Graphic Processing Unit), NPU (Neural Processing Unit), etc., and may be any semiconductor device that executes instructions stored in the memory (530) or storage device (560). The processor (510) can be configured to implement the functions and methods described in relation to FIGS. 1 to 5.

Memory (530) and storage device (560) can include various forms of volatile or non-volatile storage media. For example, memory may include ROM (read-only memory) (531) and RAM (random access memory) (532). In some embodiments, the memory (530) can be located inside or outside the processor (510) and connected to the processor (510) through various known means.

In some embodiments, at least some configurations or functions of the systems and methods according to the embodiments can be implemented as a program or software running on the computing device (50), which can be stored on a computer-readable medium.

In some embodiments, at least some configurations or functions of the systems and methods according to the embodiments may also be implemented in hardware that can be electrically connected to the computing device (50).

The detailed description of the embodiments of the invention has been provided above, but the scope of the invention is not limited to these descriptions. Various modifications and improvements by those skilled in the art using the basic concepts of the invention as defined in the following claims also fall within the scope of the invention.

1. A method for providing artificial intelligence recognition and location-based rewards and incentives for product owners and mobile application users, comprising:
registering a PRU (Passive Rewards User) and activating a PRP (Passive Reward Period);
an ARU (Active Rewards User) scanning a product and receiving a reward; and
a LMS (Location Matching Server) performing cross-verification and issuing a reward.

2. The method of claim 1, wherein:
the step of registering the PRU and activating the PRP comprises:
taking a photo of the product using the PRU's mobile device; and
an image recognition Al server providing product identification information for the product.

3. The method of claim 2, wherein:
the step of registering the PRU and activating the PRP comprises:
sending a timestamp indicating the start time of the PRP and the PRU's activation request to the LMS; and
providing the PRU's location to the LMS.

4. The method of claim 1, wherein:
the step of the ARU scanning a product and receiving a reward comprises:
an image recognition Al server providing product information for the product identified by the ARU's mobile device; and
the ARU receiving a reward.

5. The method of claim 1, wherein:
the step of the LMS performing cross-verification and issuing a reward comprises:
the ARU scanning the product with a mobile device, and the image recognition AI server identifying the product;
cross-verifying whether the PRU is within a predefined distance from the product scanned by the ARU, based on the PRU being in the POD (Product Ownership Database) and PRP, by the LMS; and
if it is confirmed to be within the predefined distance and inside the activated PRP, issuing a reward to the PRU in the POD.
